(19) United States
(12) Patent Application Publication
(10) Pub. No.: US 2018/0200943 A1
(43) Pub. Date: Jul. 19, 2018

(54) INFORMATION PROCESSING APPARATUS, THREE-DIMENSIONAL MODELING SYSTEM, AND COMPUTER READABLE MEDIUM STORING INFORMATION PROCESSING PROGRAM

(71) Applicant: FUJI XEROX CO., LTD., Tokyo (JP)

(72) Inventor: Takashi Kikumoto, Kanagawa (JP)

(21) Appl. No.: 15/648,703

(22) Filed: Jul. 13, 2017

(30) Foreign Application Priority Data
Jan. 18, 2017 (JP) 2017-007069

(51) Int. Cl. B29C 64/10; G06T 17/10; G06T 19/20; G06T 7/73

(52) U.S. Cl. CPC B29C 64/10; G06T 17/10; G06T 19/20; B33Y 30/00; G06T 2200/08; G06T 2200/04; G06T 7/75

(57) ABSTRACT

An information processing apparatus includes: a generation unit that generates plural pieces of slice data by slicing, by plural planes, a sample in which a 3D modeled object as represented by 3D data is reproduced at least partially in terms of at least one of color and shape; and an output unit that generates control data that correspond to the plural pieces of slice data and allow a post-processing apparatus to perform post-processing for manufacture of the 3D modeled object, and outputs the generated control data.

### CROSS-REFERENCE TO RELATED APPLICATIONS

This application is based on and claims priority under 35 USC 119 from Japanese Patent Application No. 2017-007069 filed on Jan. 18, 2017.

### BACKGROUND

### Technical Field

The present invention relates to an information processing apparatus, a three-dimensional modeling system, and a computer readable medium storing a information processing program.

### SUMMARY

According to an aspect of the invention, there is provided an information processing apparatus comprising: a generation unit that generates plural pieces of slice data by slicing, by plural planes, a sample in which a 3D modeled object as represented by 3D data is reproduced at least partially in terms of at least one of color and shape; and an output unit that generates control data that correspond to the plural pieces of slice data and allow a post-processing apparatus to perform post-processing for manufacture of the 3D modeled object, and outputs the generated control data.

### BRIEF DESCRIPTION OF THE DRAWINGS

Exemplary embodiments of the present invention will be described in detail based on the following figures, wherein:

FIG. 1A is a schematic diagram illustrating an example configuration of a 3D modeling system according to an exemplary embodiment of the present invention;

FIG. 1B is a block diagram showing the example configuration of the 3D modeling system according to the exemplary embodiment;

FIG. 2 is a schematic diagram showing another example configuration of the 3D modeling system according to the exemplary embodiment;

FIG. 3A is a schematic diagram illustrating an image forming process of sheet lamination 3D modeling;

FIG. 3B is a schematic diagram illustrating a post-processing process of sheet lamination 3D modeling;

FIG. 4A is a first schematic diagram showing an example slice image formed on a recording medium;

FIG. 4B is a second schematic diagram showing the example slice image formed on the recording medium;

FIG. 4C is a third schematic diagram showing the example slice image formed on the recording medium;

FIG. 5A is a schematic diagram illustrating an example of control data that specify a cutting line;

FIG. 5B is a schematic diagram illustrating another example of control data that specify the cutting line;

FIG. 6A is a schematic diagram illustrating an example of control data that specify a glue application region;

FIG. 6B is a schematic diagram illustrating another example of control data that specify the glue application region;

FIG. 7 is a block diagram showing an example electrical configuration of an information processing apparatus according to the exemplary embodiment;

FIG. 8 is a block diagram showing an example functional configuration of the information processing apparatus according to the exemplary embodiment;

FIG. 9 is a flowchart showing an example processing procedure of an information processing program according to the exemplary embodiment;

FIG. 10 is a sequence diagram illustrating a main operation of 3D modeling of the 3D modeling system according to the exemplary embodiment;

FIG. 11 is a flowchart showing an example processing procedure of image data output processing program of a reduction mode according to the exemplary embodiment;

FIG. 12A is a schematic diagram illustrating an example of how slice image data of a sample are generated in a reduction mode;

FIG. 12B is a schematic diagram showing examples of an intended 3D modeled object and its sample manufactured in the reduction mode;

FIG. 13 is a flowchart showing an example processing procedure of an image data output processing program of a partial modeling mode according to the exemplary embodiment;

FIG. 14A is a schematic diagram illustrating an example of how slice image data of a sample are generated in a partial modeling mode;

FIG. 14B is a schematic diagram showing examples of an intended 3D modeled object and its sample manufactured in the partial modeling mode;

FIG. 15 is a flowchart showing an example processing procedure of an image data output processing program of a partial coloring mode according to the exemplary embodiment;

FIG. 16A is a schematic diagram illustrating an example of how slice image data of a sample are generated in the partial coloring mode;

FIG. 16B is a schematic diagram showing examples of an intended 3D modeled object and its sample manufactured in the partial coloring mode;

FIG. 17 is a flowchart showing an example processing procedure of an image data output processing program of a thick paper mode according to the exemplary embodiment;

FIG. 18 is a schematic diagram illustrating an example of how slice image data of a sample are generated in the thick paper mode;

FIG. 19 is a flowchart showing an example processing procedure of an image data output processing program of a non-coloring mode according to the exemplary embodiment; and

FIG. 20 is a schematic diagram showing examples of an intended 3D modeled object and its sample manufactured in the non-coloring mode.

### DESCRIPTION OF SYMBOLS

10: Information processing apparatus
12: Image forming apparatus
14: 3D modeling post-processing apparatus (post-processing apparatus)
16: Recorded media storing mechanism
18: Communication line
20: Glue applying unit
22: Cutting-out unit
24: Compression bonding unit
26: Conveyance path
30: Information processing unit
40: File format conversion unit
42: Raster processing unit
44: 3D data processing unit
45: Slice processing unit
46: Image data generation unit
47: Control data generation unit
48: Control data memory
50: Recording medium
52: Lamination component
53: Unnecessary portion
54: Cutting line
56: Colored region
58: Glue application region
D: Removal target
M: 3D model
Mn: Slice image
P: 3D modeled object

### DETAILED DESCRIPTION

An exemplary embodiment of the present invention will be hereinafter described in detail with reference to the drawings.

### <Three-Dimensional Modeling System>

### (Overall Configuration)

First, a three-dimensional (3D) modeling system according to the exemplary embodiment of the invention will be described. The 3D modeling system according to the exemplary embodiment manufactures a three-dimensional (3D) modeled object by a sheet lamination 3D modeling method. In the sheet lamination 3D modeling method, plural pieces of slice data are generated by slicing three-dimensional (3D) data of a 3D model by plural surfaces and a series of slice images is formed on plural sheet-like recording media such as paper sheets on the basis of the plural pieces of slice data. Then 3D modeling post-processing is performed on the plural recording media on which the series of slice images is formed; for example, the plural recording media are laminated by subjecting them to certain processing. How to generate slice data will be described later. The term “series of slice images” means that the slice images correspond to pieces of slice data generated on the basis of the 3D data.

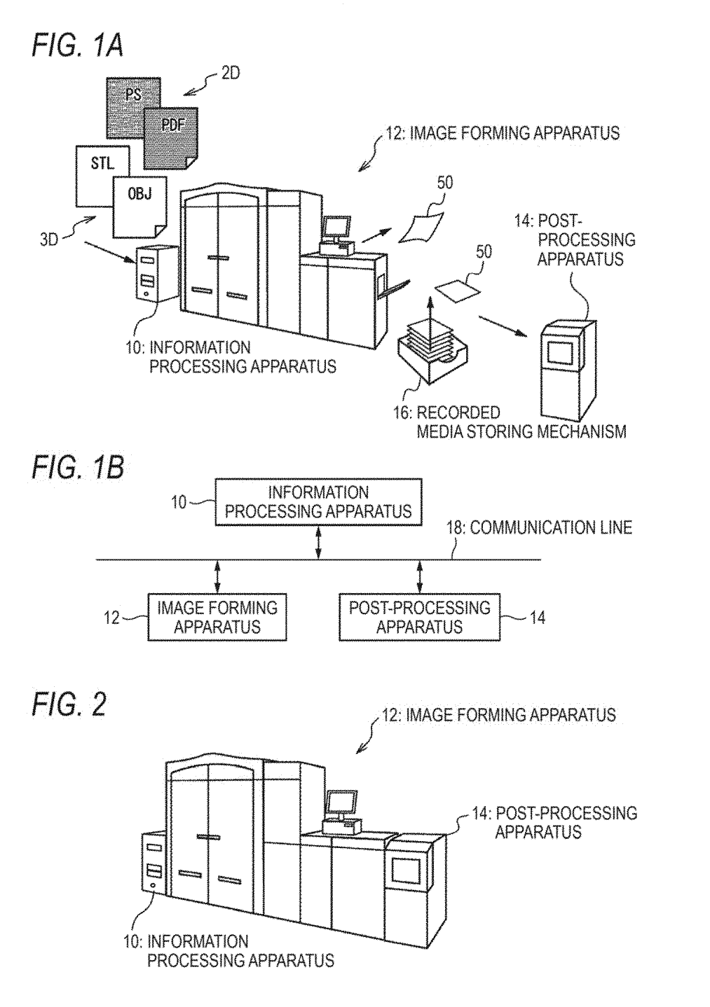

FIGS. 1A and 1B are a schematic diagram and a block diagram, respectively, illustrating an example configuration of the 3D modeling system according to the exemplary embodiment. FIG. 2 is a schematic diagram showing another example configuration of the 3D modeling system according to the exemplary embodiment.

As shown in FIG. 1A, the 3D modeling system according to the exemplary embodiment is equipped with an information processing apparatus 10, an image forming apparatus 12, and a 3D modeling post-processing apparatus 14. As shown in FIG. 1B, the information processing apparatus 10, the image forming apparatus 12, and the 3D modeling post-processing apparatus 14 are connected to each other so as to be able to communicate with each other through a communication line 18. In the following description, the 3D modeling post-processing apparatus 14 will be abbreviated as a “post-processing apparatus 14.”

The image forming apparatus 12 forms an image on a recording medium 50 on the basis of raster image data. The raster image data is an example of the term “image formation info mat ion” as used in the claims. In the exemplary embodiment, the image forming apparatus 12 is not an apparatus dedicated to 3D modeling. The image forming apparatus 12 functions as an ordinary image forming apparatus when it is instructed to perform image formation base on two-dimensional (2D) image data. As such, the information processing apparatus 10 performs different kinds of information processing depending on which of image formation based on 2D image data and 3D modeling based on 3D data it should work for.

The image forming apparatus 12 is an apparatus for forming an image on a recording medium by electrophotography, for example. In this case, the linage forming apparatus 12 includes a photoreceptor drum, a charging device, an exposing device, a developing device, a transfer device, a fusing device, etc. The charging device charges the photoreceptor drum. The exposing device exposes the charged surface of the photoreceptor drum to light that reflects an image to be formed. The developing device develops an electrostatic latent image formed on the photoreceptor drum with toner. The transfer device transfers a toner image formed on the photoreceptor drum by exposure to a recording medium. The fusing device fuses the toner image transferred to the recording medium. The image forming apparatus 12 may be an inkjet recording apparatus, in which case the image forming apparatus 12 includes an inkjet recording head for ejecting ink droplets toward a recording medium according to an image to be formed and other components.

If instructed to work for 3D modeling based on 3D data, the information processing apparatus 10 generates plural pieces of slice data on the basis of the 3D data. Then, to enable formation of a series of raster images, the information processing apparatus 10 generates a series of raster image data on the basis of the plural pieces of slice data and outputs the generated series of raster image data to the image forming apparatus 12. On the other hand, if instructed to work for image formation based on 2D image data, the information processing apparatus 10 generates raster image data on the basis of the 2D image data and outputs the generated raster image data to the image forming apparatus 12.

If instructed to work for 3D modeling based on 3D data, the information processing apparatus 10 further generates a series of control data on the basis of the plural pieces of slice data. The series of control data is data for allowing the post-processing apparatus 14 to perform 3D modeling post-processing. As described later, element control data include control data that specify a cutting line along which to cut out a lamination component from a recording medium and control data that specify a glue application region of the recording medium where to apply glue.

The post-processing apparatus 14 performs 3D modeling post-processing on recording media 50 on which a series of slice images are formed. As shown in FIG. 1A, the post-processing apparatus 14 may be disposed so as not to share a recording medium conveyance path with the image forming apparatus 12 (offline or near-line). Alternatively, as shown in FIG. 2, the post-processing apparatus 14 may be disposed so as to share a recording medium conveyance path with the image forming apparatus 12 (in-line)

Where the post-processing apparatus 14 does not to share a conveyance path with the image forming apparatus 12, plural recording media 50 on which a series of slice images are formed are stacked in order of formation of the slice images and stored in a recorded media storing mechanism 16 such as a stacker. The bundle of (i.e., stacked) plural recording media 50 is taken out of the recorded media storing mechanism 16 and transferred to the post-processing apparatus 14 together. On the other hand, where the post-processing apparatus 14 shares a conveyance path with the image forming apparatus 12, recording media 50 on which respective slice images are formed are conveyed to the post-processing apparatus 14 one by one.

### (Sheet Lamination 3D Modeling)

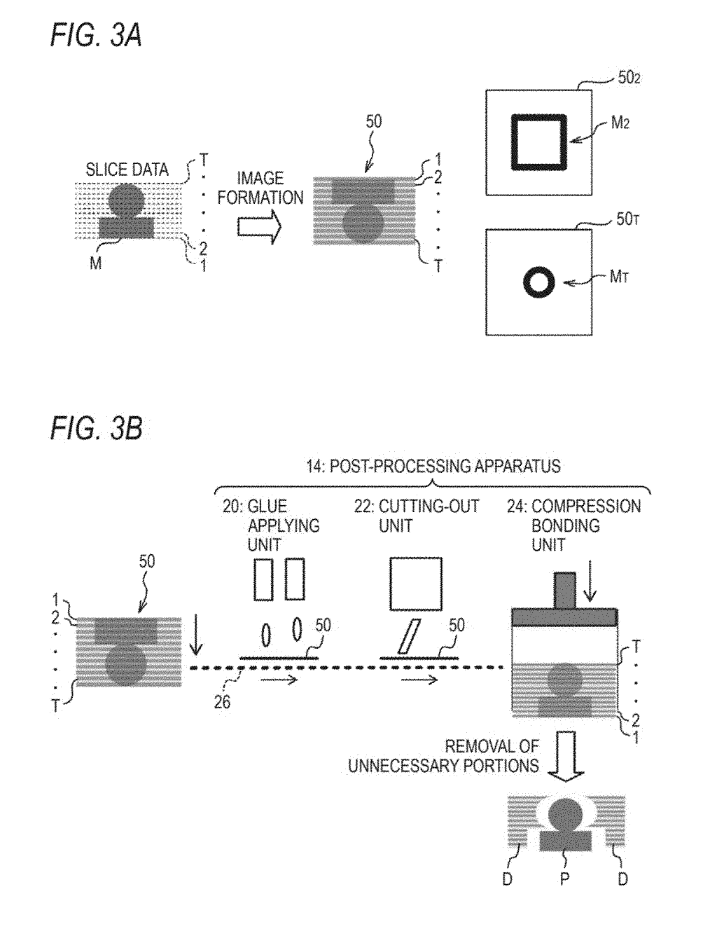

Next, individual processes of sheet lamination 3D modeling will be described. FIG. 3A is a schematic diagram illustrating an image forming process of sheet lamination 3D modeling, and FIG. 3B is a schematic diagram illustrating a post-processing process of sheet lamination 3D modeling.

First, raster image data of slice images are generated as shown in FIG. 3A. Although the details will be described later, the information processing apparatus 10 generates plural pieces of slice data on the basis of 3D data of a 3D model M. The slice data represent sectional images obtained by slicing the 3D model M by slicing planes. In the exemplary embodiment, T (first to Tth) pieces of slice data are generated using T (first to Tth) slicing planes. Each of the T pieces of slice data is converted into YMCK raster image data for formation of the corresponding one of T (first to Tth) slice images.

Next, as shown in FIG. 3A, slice images are formed on respective recording media. The image forming apparatus 12 forms a series of slice images on recording media 50 on the basis of the series of raster image data. The plural recording media 50₁ to 50_{T} on which the series of slice images are formed are stacked in order of formation of the slice images. An nth slice image is formed on an nth recording medium 50ₙ, n being a number that is one of “1” to “T.”

In the illustrated example, the T (first to Tth) slice images are formed in order that the number representing each of them descends from “T” to “1.” The plural recording media 50₁ to 50_{T} are stacked

in the order that the number representing each of them descends from “T” to “1” with the recording medium 50_{T} on which the Tth slice image is formed being the lowest layer. Since the plural recording media 50₁ to 50_{T} are stacked in this order, the post-processing process that follows is supplied with the plural recording media 50₁ to 50_{T} in order that the number representing each of them ascends from “1” to “T.” As such, the image forming apparatus 12 forms T slice images on recording media 50 in the order that is reverse to the order in which the post-processing apparatus 14 performs post-processing.

Subsequently, as shown in FIG. 3B, the recording media 50 on which the respective slice images are formed are subjected to post processing. In the exemplary embodiment, the post-processing apparatus 14 is equipped with a glue applying unit 20 which performs a glue applying operation, a cutting-out unit 22 which performs a cutting-out operation, and a compression bonding unit 24 which performs a compression bonding operation. The glue applying unit 20, the cutting-out unit 22, and the compression bonding unit 24 are arranged in this order along a conveyance path 26 for conveying recording media 50. The post-processing apparatus 14 acquires a series of control data corresponding to the series of slice images from the information processing apparatus 10.

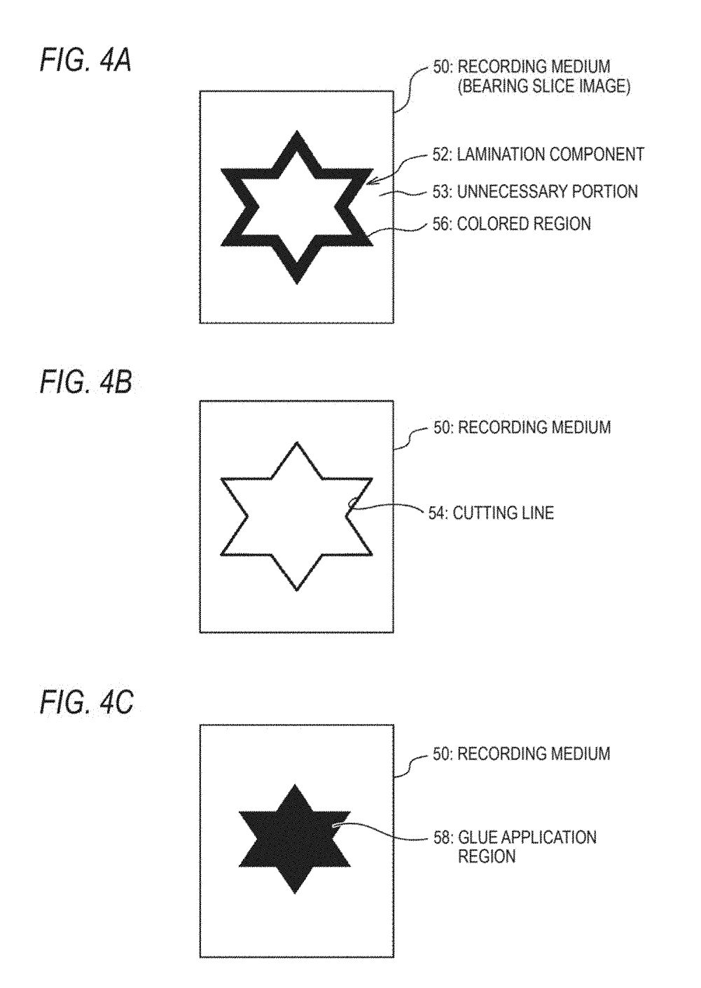

The slice image will now be described. FIGS. 4A-4C are schematic diagrams showing an example slice image formed on a recording medium 50. As shown in FIG. 4A, a slice image formed on a recording medium 50 consists of a lamination component 52 to become part of a 3D modeled object when subjected to lamination and an unnecessary portion 53. The lamination component 52 has a colored region 56 which is a peripheral region having a preset width. As shown in FIG. 4B, the outer circumferential line of the lamination component 52 is a cutting line 54 along which to cut out the lamination component 52 from the recording medium 50.

As shown in FIG. 4C, a glue application region 58 is set inside the outer circumferential line (cutting line 54)of the lamination component 52; for example, the glue application region 58 is the region occupying the inside of the colored region 56. Although glue may be applied to the entire surface of the recording medium 50 including the unnecessary portion 53, setting the glue application region 58 as a region located inside the outer circumferential line of the lamination component 52 makes it easier to remove removal target portions D (see FIG. 3B) than in the case that glue is applied to the entire surface of the recording medium 50. Furthermore, setting the glue application region 58 as a region located inside the outer circumferential line of the lamination component 52 prevents an event that glue sticks out of the lamination component 52 in a compression bonding operation that is performed after glue application.

A width of the colored region 56 and a retreat width of the glue application region 58 from the outer circumferential line of the lamination component 52 may be set when a user inputs instructions about 3D modeling by, for example, displaying a setting picture on a display 34 of the information processing apparatus 10 and receiving settings from the user through an operation unit 32. Alternatively, preset initial settings may be employed.

Element control data include control data that specify the cutting line 54 and control data that specify the glue application region 58. For example, the control data that specify the cutting line 54 are coordinate data of points located on a route of the cutting line 54. The control data that specify the glue application region 58 are coordinate data of points in the glue application region 58.

Recording media 50 are supplied to the glue applying unit 20 one by one from a bundle of plural recording media 50. The glue applying unit 20 applies glue to the glue application region 58 of each recording medium 50 on the basis of control data that specify the glue application region 58. The glue applying unit 20 may be equipped with a glue ejection head for ejecting glue, which is moved in a lamination direction (Z direction) and directions parallel with the plane of the recording medium 50 (X and Y directions). Glue is applied to the glue application region 58 of the recording medium 50 as the glue ejection head scans the glue application region 58 while ejecting glue. Upon completion of the glue applying operation, the recording medium 50 is supplied to the cutting-out unit 22.

The cutting-out unit 22 forms a cut in each recording medium 50 along the cutting line 54 on the basis of control data that specify the cutting line 54. For example, the cutting-out unit 22 may be a cutter having a blade. The blade of the cutter is moved in the lamination direction (Z direction)and the directions parallel with the plane of the recording medium 50 (X and Y directions). A cut is formed in the recording medium 50 by moving the blade of the cutter in the X and Y directions while pressing it against the recording medium 50.

A cutting depth is determined by adjusting the position of the blade of the cutter in the lamination direction. The cutting depth may be such that the cut does not reach the back surface of each recording medium 50, in which case the lamination component 52 is not separated from the recording medium 50 and hence can be prevented from being lost in the process of conveyance of the recording medium 50.

It suffices that the cutter have a function of forming a cut along the cutting line 54 of a recording medium 50, and the cutter is not limited to a mechanical cutter that presses a blade against the recording medium 50. For example, the cutter may be an ultrasonic cutter that forms a cut by applying ultrasonic waves to a recording medium 50 or a laser cutter that forms a cut by irradiating a recording medium 50 with laser light.

Instead of forming a cut in a recording medium 50, the cutting-out unit 22 may form plural perforations in a recording medium 50 along the cutting line 54. Where plural perforations are formed, the lamination component 52 is kept connected to the recording medium 50 and hence can be prevented from being lost in the process of conveyance of the recording medium 50 even more reliably.

Each recording medium 50 that has been subjected to the cutting operation is supplied to the compression bonding unit 24. The compression bonding unit 24 stacks received recording media 50 successively. The plural recording media 50₁ to 50_{T} are stacked in order that the number representing each of them ascends from “1” to “T.” The compression bonding unit 24 compression-bonds the bundle of stacked plural recording media 50 together by pressing it in the lamination direction. During the pressure bonding, each of the plural glue-applied recording media 50₁ to 50_{T} are bonded to the recording media 50 located immediately above and below in the glue application regions 58.

The recording media 50 that have been subjected to the cutting-out operation are composed of the lamination components 52 that constitute a 3D modeled object P as a result of the lamination and the unnecessary portions 53. In this state, the unnecessary portions 53 are not removed and remain parts of the recording media 50. The unnecessary portions 53 serve as a support member for supporting the 3D modeled object P that is a laminate of the lamination components 52. After completion of the lamination operation of the compression bonding unit 24, removal target portions D are separated from the laminate of the lamination components 52 of the recording media 50, whereby the 3D modeled object P are separated.

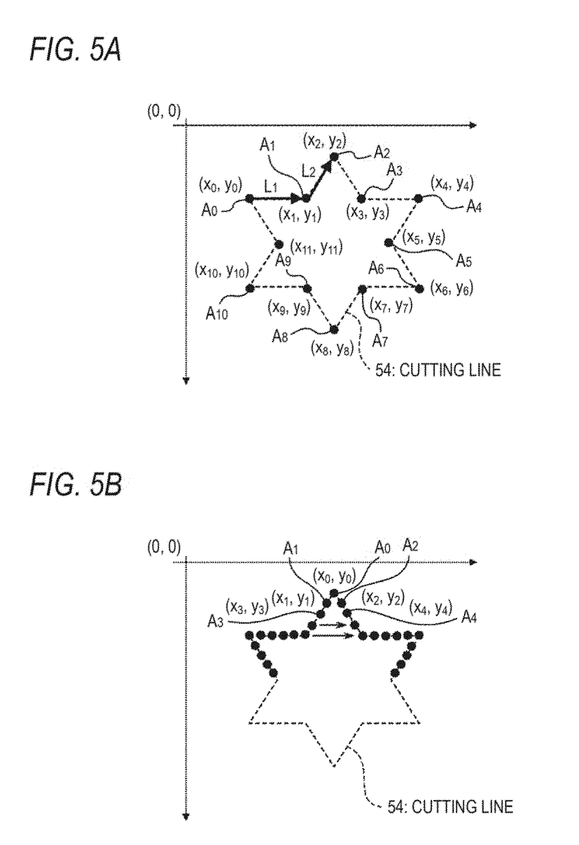

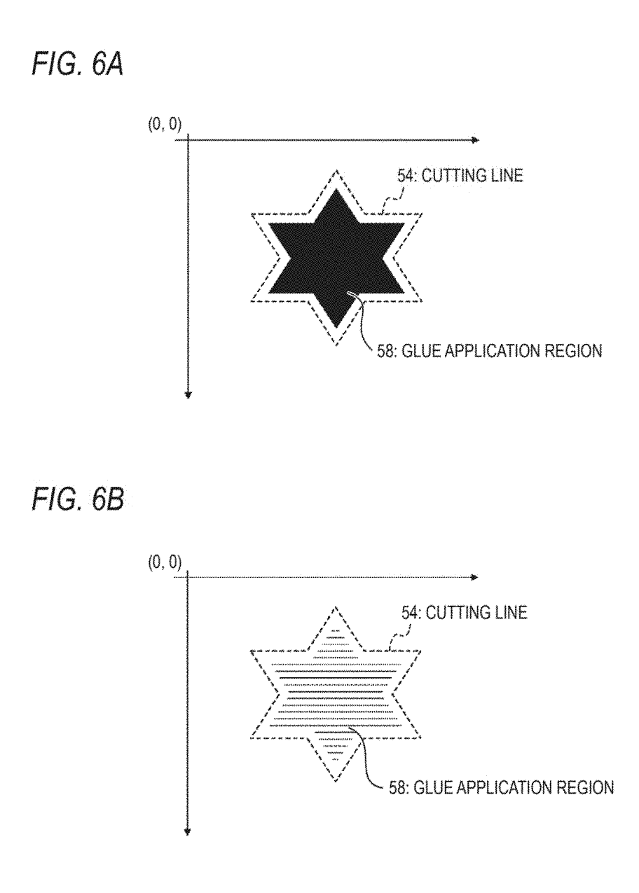

Next, examples of control data will be described. FIGS. 5A and 5B are schematic diagrams illustrating examples of control data that specify a cutting line 54. FIGS. 6A and 6B are schematic diagrams illustrating examples of control data that specify a glue application region 58. As described later, slice data include coordinate data of apices of an intersection regions where polygons intersect a slicing plane. The intersection regions exist along the outer circumferential line of a lamination component 52. Thus, as shown in FIG. 5A, coordinate data of respective points located on a route of a cutting line 54, such as coordinates (x₀, y₀) of point A₀, are made control data that specify the cutting line 54.

In the illustrated example, a star-shaped lamination component 52 has eleven apices A₀ to A₁₀. For example, if point A₀ is employed as a start point, the cutting line 54 is specified by passing the points A₀ to A₁₀ in order of A₀→A₂→A₃→A₄→A₅→A₆→A₇→A₈→A₉→A₁₀.

As shown in FIG. 5B, where plural perforations are to be formed, coordinate data of respective perforations located on a route of a cutting line 54 are made control data that specify the cutting line 54. For example, if point A₀ is employed as a start point, the cutting line 54 is specified by passing points of the perforations in order of their formation (e.g., A₀→A₂→A₃→A₄. . . ).

As shown in FIG. 6A, coordinate data of respective points of a glue application region 58 are made control data that specify the glue application region 58. The glue application region 58 is one size smaller than the lamination component 52 and is set inside the outer circumferential line of the lamination component 52. A glue application region 58 may be specified by reducing the image of the lamination component 52. In this case, the glue application region 58 is disposed so that its center of gravity coincides with that of the image of the lamination component 52. Coordinate data of respective points of the glue application region 58 are determined on the basis of its retreat width from the outer circumferential line of the lamination component 52 and coordinate data of points located on a route of a cutting line 54.

As shown in FIG. 6B, it is not necessary to apply glue in the entire glue application region 58. Glue may be applied in selected portions of the glue application region 58. Furthermore, the glue density need not be constant over the entire glue application region 58. Where the glue density is set variable, the glue density may be set higher in a peripheral region than in a central region.

The origin of control data that specify a cutting line 54 and the origin of control data that specify a glue application region 58 are set the same as the origin of slice image formation. Where the post-processing apparatus 14 has an image reading function, a procedure may be employed that the image forming apparatus 12 forms a mark image indicating the origin of control data on a recording medium 50 together with a slice image and the post-processing apparatus 14 acquires position information indicating the origin of control data by reading the mark image.

The form of control data is not limited to coordinate data. For example, control data may be image data in which a cutting line 54, a glue application region 58, etc. are represented by figures or images, such as binary raster image data. In the case of binary raster image data, in the example shown in FIG. 4B, the pixel values of the cutting line 54 are made “1” and those of the other regions are made “0.” In the example shown in FIG. 4, the pixel values of the glue application region 58 are made “1” and those of the other regions are made “0.” For example, the glue ejection head of the glue applying unit 20 ejects glue toward a recording medium 50 when the pixel value is equal to “1” and does not eject glue toward the recording medium 50 when the pixel value is equal to “0.”

### <Information Processing Apparatus 10>

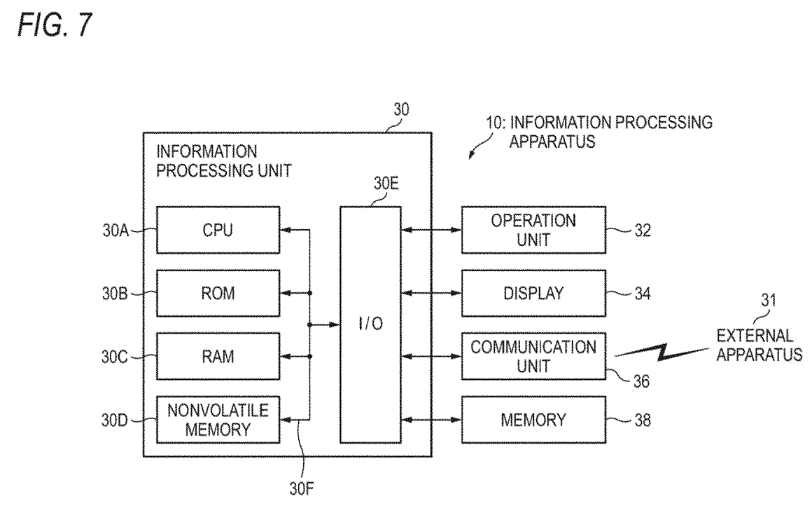

Next, the information processing apparatus 10 according to the exemplary embodiment of the invention will be described. FIG. 7 is a block diagram showing the electrical configuration of the information processing apparatus 10 according to the exemplary embodiment. As shown in FIG. 7, the information processing apparatus 10 is equipped with an information processing unit 30, an operation unit 32 for receiving a user operation, a display 34 for displaying information to a user, a communication unit 36 for communicating with an external apparatus 31, and a memory 38 such as an external storage device. The operation unit 32, the display 34, the communication unit 36, and the memory 38 are connected to an input/output interface (I/O) 30E of the information processing unit 30.

The information processing unit 30 is equipped with a CPU (central processing unit) 30A, a ROM (read-only memory) 30B, a RAM (random access memory) 30C, a nonvolatile memory 30D, and the I/O 30E. The CPU 30A, the ROM 30B, the RAM 30C, the nonvolatile memory 30D, and the I/O 30E are connected to each other by a bus 30F. The CPU 30A reads cut a program from the ROM 30B and executes the program using the RAM 30C as a working area.

The operation unit 32 receives a user operation that is made through a mouse, a keyboard, etc. The display 34 displays various pictures to a user using a display device. The communication unit 36 communicates with the external apparatus 31 through a wired or wireless communicate line. For example, the communication unit 36 functions as an interface for communicating with 31 external apparatus 31 such as a computer that is connected to a network such as the Internet. The memory 38 is equipped with a storage device such as a hard disk drive.

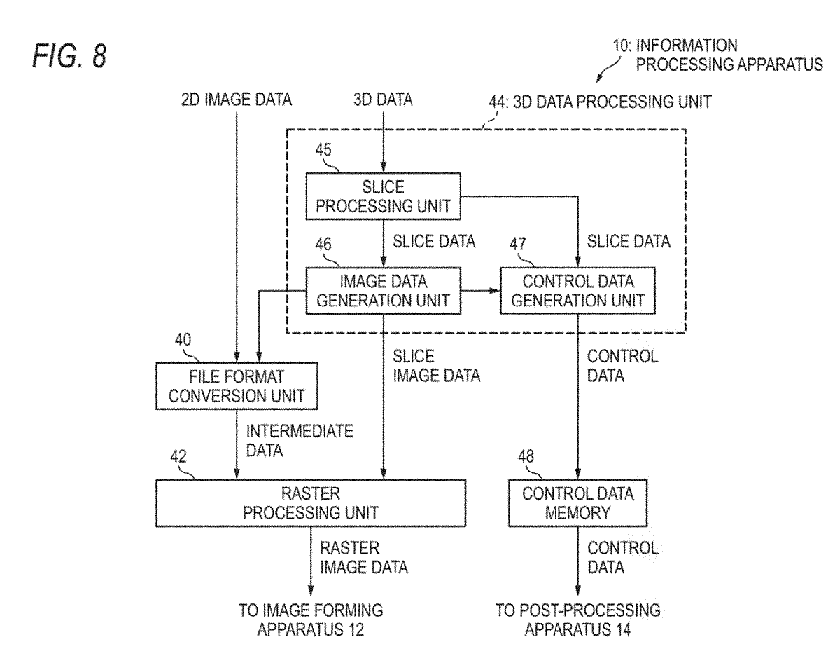

FIG. 8 is a block diagram showing the functional configuration of the information processing apparatus 10 according to the exemplary embodiment. As shown in FIG. 8, the information processing apparatus 10 is equipped with a file format conversion unit 40, a raster processing unit 42, a 3D data processing unit 44, and a control data memory 48.

When receiving data written in a page description language (hereinafter referred to as “PDL data”), the file format conversion unit 40 converts the received PDL data into intermediate data.

The raster processing unit 42 generates raster image data by rasterizing the intermediate data produced by the file format conversion unit 40. Furthermore, the raster processing unit 42 generates raster image data by rasterizing slice image data generated by an image data generation unit 46 (described later). The raster processing unit 42 is an example of the term “output unit” as used in the embodiment.

The 3D data processing unit 44 generates slice image data and control data by processing received 3D data. More specifically, the 3D data processing unit 44 is equipped with a slice processing unit 45, the image data generation unit 46, and a control data generation unit 47. The slice processing unit 45 generates slice data on the basis of received 3D data. The image data generation unit 46 generates slice image data on the basis of the slice data received from the slice processing unit 45. The control data generation unit 47 generates control data on the basis of the slice data received from the slice processing unit 45. The control data memory 48 stores the control data received from the control data generation unit 47.

### (2D Data Processing)

Two-dimensional data processing on 2D image data will be described below. When image formation based on 2D image data is commanded, the 2D image data are data that have been acquired as PDL data. The PDL data are converted by the file format conversion unit 40 into intermediate data, which are output to the raster processing unit 42. The intermediate data are rasterized by the raster processing unit 42 into raster image data of 2D images, which are output to the image forming apparatus 12.

The intermediate data are interval data in which objects (e.g., font characters, graphic figures, and image data) that are image elements of each page image are divided so as to correspond to respective raster scanning lines. The interval of each piece of interval data is represented by sets of coordinates of the two ends of the interval, and each piece of interval data includes information indicating pixel values of respective pixels in the interval. The data transfer rate in the information processing apparatus 10 is increased because the PDL data are converted into the intermediate data and then the latter are transferred.

### (3D Data Processing)

Three-dimensional data processing on 3D data will be described below. When 3D modeling based on 3D data is commanded, 3D data of a 3D model M are acquired. The slice processing unit 45 generates slice data on the basis of the 3D data, and outputs the generated slice data to the image data generation unit 46 and the control data generation unit 47. The 3D data and the slice data will be described below in detail.

For example, the 3D data of the 3D model M are OBJ format 3D data (hereinafter referred to as “OBJ data”). In the case of OBJ data, the 3D model M is expressed as a set of polygons (triangles). Alternatively, the 3D data may be of another format such as the STL format. Since STL format 3D data have no color information, color information is added when STL format 3D data are used.

The following description will be directed to the case that the 3D data are OBJ data. The OBJ data include an OBJ file relating to shape data and an MTL file relating to color information. In the OBJ file, surface numbers specific to respective polygons (triangles), coordinate data of the apices of the polygons, etc. are defined so as to be correlated with the respective polygons. In the MTL file, pieces of color information are defined so as to be correlated with the respective polygons.

As for the setting of a direction in which to slice the 3D model M, for example, planes that are parallel with a ground surface (XY plane) on which the 3D model M is placed are employed as slicing planes. In this case, for example, a lowest layer of the 3D model M is set as a first slicing plane. Slice data are generated every time the slicing surface is shifted by a predetermined lamination pitch (distance) in a lamination direction (Z-axis direction).

The lowest slicing plane is given a number “1” and the slicing plane number is increased by “1” every time the slicing surface is shifted. The example shown in FIG. 3A has T slicing planes having numbers “1” to “T.” Slice data represent sectional images obtained by slicing the 3D model M by the slicing planes, respectively. More specifically, each piece of slice data represents a sectional image of the 3D model M in the form of a slicing plane number, coordinate data of the apices of intersection regions where polygons intersect the slicing plane, and pieces of color information that are set for the respective polygons that intersect the slicing plane. T pieces of slice data (first to Tth slice data) are generated by T respective slicing planes.

The image data generation unit 46 generates slice image data on the basis of the slice data generated by the slice processing unit 45. The slice data are converted into slice image data of a file format such as JPEG. Colored regions may be added to each slice image in generating its slice image data. The generated slice image data are output to the raster processing unit 42. The raster processing unit 42 generates raster image data by rasterizing the slice image data generated by the image data generation unit 46, and outputs the generated raster image data to the image forming apparatus 12.

Alternatively, the image data generation unit 46 may be configured so as to cause generation of intermediate data. In this case, the image data generation unit 46 generates PDL data on the basis of the slice data generated by the slice processing unit 45, and outputs the generated PDL data to the file format conversion unit 40. The file format conversion unit 40 converts the PDL data into intermediate data, and outputs the intermediate data to the raster processing unit 42. The raster processing unit 42 generates raster image data of the slice image data by rasterizing the intermediate data, and outputs the generated raster image data to the image forming apparatus 12.

The control data generation unit 47 generates control data on the basis of the slice data generated by the slice processing unit 45. The generated control data are stored in the control data memory 48 so as to be correlated with respective slice image numbers (which are the same as the respective slicing plane numbers). The control data are read out from the control data memory 48 and output to the post-processing apparatus 14 upon reception of a post-processing start instruction from a user.

### (Sample Manufacture Processing)

Next, sample manufacture processing to be performed on 3D data will be described. In the exemplary embodiment, if manufacture of a sample of a 3D modeled object is commanded prior to 3D modeling based on 3D data, a sample is manufactured in which an intended 3D modeled object is reproduced at least partially in terms of at least one of color and shape by one of the following method-1 to method-5:

Method-1 (reduction mode): A sample is manufactured as a reduced version of the intended 3D modeled object.

Method-2 (partial modeling mode): A sample is manufactured by extracting only one or plural portions of the intended 3D modeled object.

Method-3 (partial coloring mode): A sample is manufactured by coloring only one or plural portions of the intended 3D modeled object.

Method-4 (thick paper mode): A sample of the intended 3D modeled object is manufactured using paper sheets that are thicker than recording media 50 for manufacture of the intended 3D modeled object.

Method-5 (non-coloring mode): A colorless sample of the intended 3D modeled object is manufactured.

The exemplary embodiment is directed to a case that data indicating a sample manufacturing method that was selected by a user in advance is stored in the memory 38 and the selected method is judged by reading this data. However, how to judge a sample manufacturing method is not limited to the above; in performing sample manufacture processing, the information processing apparatus 10 may urge a user to select a sample manufacturing method and employ it.

First, the slice processing unit 45 acquires 3D data of a 3D model M and generates plural pieces of slice data by slicing the 3D data by plural planes. The generated plural pieces of slice data are output to the image data generation unit 46 and the control data generation unit 47.

The image data generation unit 46 performs image data output processing of generating a series of slice image data by processing the received slice data according to the set sample manufacturing method and output ting the generated series of slice image data. For example, the slice data are converted into slice image data of a file format such as JPEG, which is output to the raster processing unit 42.

The raster processing unit 42 generates raster image data by rasterizing the slice image data generated by the image data generation unit 46, and outputs the generated raster image data of the slice image data to the image forming apparatus 12.

Alternatively, as described above, the image data generation unit 46 may be configured so as to generate intermediate data. In this case, the image data generation unit 46 generates PDL data on the basis of the slice data received from the slice processing unit 45, and outputs the generated PDL data to the file format conversion unit 40. The file format conversion unit 40 converts the PDL data into intermediate data, and outputs the intermediate data to the raster processing unit 42. The raster processing unit 42 generates raster image data by rasterizing the intermediate data, and outputs the generated raster image data of the slice image data to the image forming apparatus 12.

The control data generation unit 47 generates control data on the basis of the plural pieces of slice data received from the slice processing unit 45 and the series of slice image data received from the image data generation unit 46. The generated control data are stored in the control data memory 48 so as to be correlated with respective slice image numbers (which are the same as the respective slicing plane numbers). The control data are read out from the control data memory 48 and output to the post-processing apparatus 14 upon reception of a post-processing start instruction from a user.

Although in the exemplary embodiment the information processing apparatus 10 is equipped with the control data memory 48, a storage unit for storing control data may be disposed outside the information processing apparatus 10. For example, the post-processing apparatus 14 may be equipped with a storage unit for storing control data. In this case, the control data generated by the information processing apparatus 10 are stored in the storage unit of the post-processing apparatus 14 and read out from it when used.

The storage unit for storing control data may be a computer-readable, portable storage medium such as a USB (Universal Serial Bus) memory. In this case, control data generated by the information processing apparatus 10 are stored in the computer-readable, portable storage medium. The control data stored in this storage medium are read out from it by a data reading mechanism such as a drive provided in the information processing apparatus 10 or the post-processing apparatus 14 and used in the post-processing apparatus 14.

### < Information Processing Program>

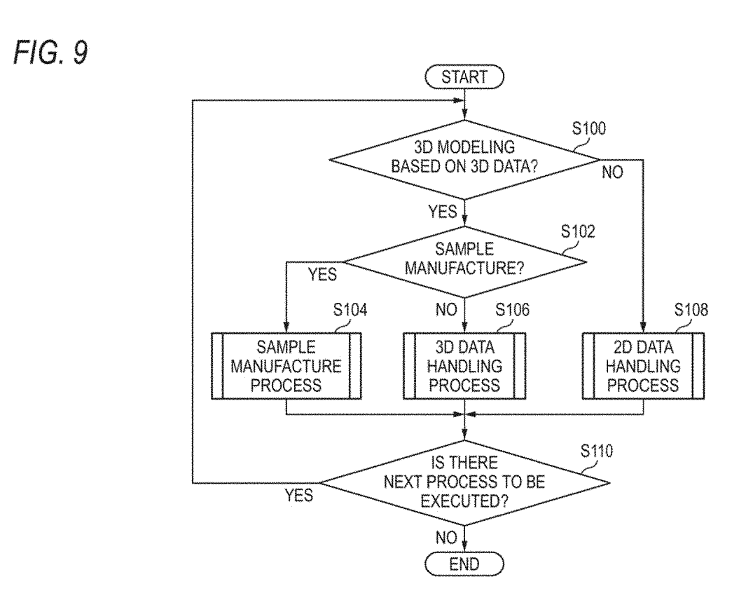

Next, an information processing program according to the exemplary embodiment will be described. FIG. 9 is a flowchart showing an example processing procedure of the information processing program according to the exemplary embodiment. The information processing program is stored in the ROM 30B of the information processing apparatus 10. The information processing program is read out from the ROM 30B and executed by the CPU 30A of the information processing apparatus 10. Execution of the information processing program is started upon reception of an image formation instruction or a 3D modeling instruction from a user.

Although the exemplary embodiment is directed to the case that the information processing program is stored in the ROM 30B of the information processing apparatus 10 in advance, the invention is not limited to this case. For example, the information processing program may be provided being stored in a computer-readable, portable storage medium such as a magneto-optical disc, a CD-ROM (compact disc read-only memory), or a USB memory or provided over a network.

First, at step S100, the CPU 30A judges whether instruction data commands 3D modeling based on 3D data. If 3D modeling based on 3D data is commanded, the CPU 30A executes the process shown in step S102. If not, the CPU 30A executes the process shown in step S108.

At step S102, the CPU 30A judges whether the instruction data commands manufacture of a sample of an intended 3D modeled object based on 3D data. If the instruction data commands manufacture of a sample of an intended 3D modeled object based on 3D data, the CPU 30A executes the process shown in step S104. If not, the CPU 30A executes the process shown in step S106.

At step S104, the CPU 30A performs the above-described sample manufacture processing. At step S106, the CPU 30A performs the above-described 3D data processing. On the other hand, at step S108, the CPU 30A performs the above-described 2D data processing.

At step S110, the CPU 30A judges whether there is a next process to be executed. If receiving an instruction to manufacture a sample, perform 2D image formation, or perform 3D modeling during execution of the sample manufacture processing, 3D data processing, or 2D data processing, the CPU 30A executes the process shown in step S100 because there is a next process to be executed. If judging at step S110 that there is no next process to be executed, the CPU 30A finishes the execution of the information processing program.

### <Main Operation of 3D Modeling System>

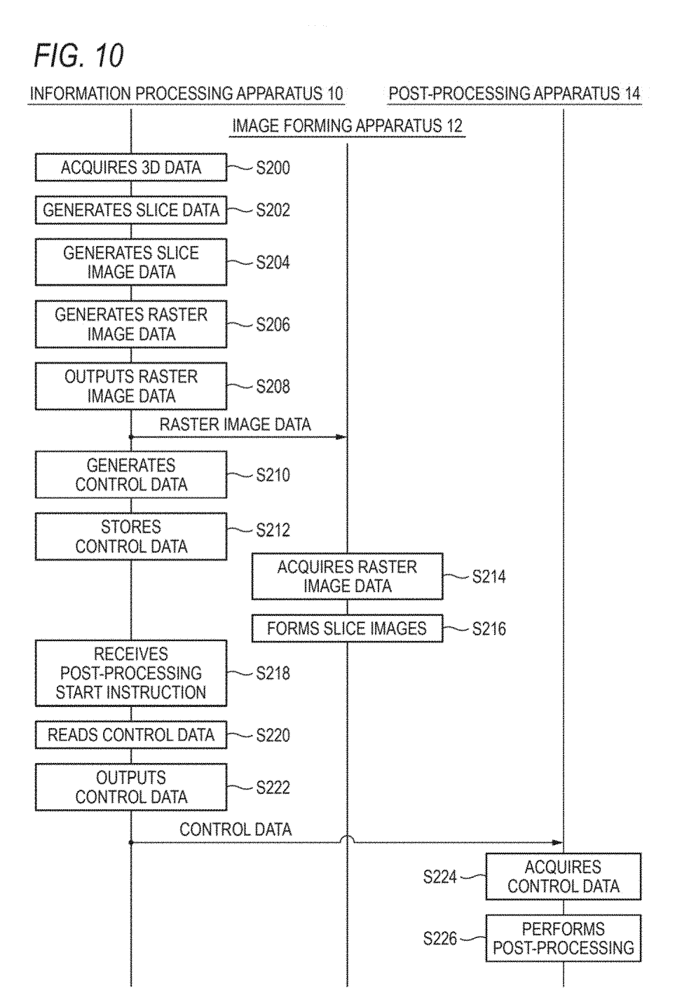

A main operation of the 3D modeling system according to the exemplary embodiment will now be described. FIG. 10 is a sequence diagram illustrating a main operation of 3D modeling of the 3D modeling system according to the exemplary embodiment.

As shown in FIG. 10, upon receiving 3D data at step S200, at step S202 the information processing apparatus 10 generates a series of slice data on the basis of the received 3D data.

At step S204, the information processing apparatus 10 generates a series of slice image data on the basis of the series of slice data. The information processing apparatus 10 generates a series of raster image data on the basis of the series of slice image data at step S206, and outputs the generated series of raster image data to the image farming apparatus 12 at step S208.

The information processing apparatus 10 generates a series of control data on the basis of the series of slice image data at step S210, and outputs the generated series of control data to the storage unit at step S212. The information processing apparatus 10 may output the raster image data to the image forming apparatus 12 at step S208 after the generation and storage of the control data.

The image forming apparatus 12 acquires the series of raster image data at step S214, and forms slice images on respective recording media 50 on the basis of the acquired series of raster image data at step S216. The plural recording media 50 on which the series of slice images has been formed are stacked in order of formation of the slice images and housed in the recorded media storing mechanism such as a stacker.

Upon receiving a post-processing start instruction from a user at step S218, the information processing apparatus 10 reads out the series of control data from the storage unit at step S220 and outputs the read-out series of control data to the post-processing apparatus 14 at step S222.

The post-processing apparatus 14 acquires the series of control data at step S224, and, at step S226, performs post-processing on the plural recording media 50 on which the respective slice images are formed.

A bundle of recording media 50 on which the series of slice images is formed and that are stacked in order of their formation is set in the post-processing apparatus 14. The post-processing apparatus 14 performs post-processing while taking out the recording media 50 one by one from the top in their stacking direction. That is, the plural recording media 50 are subjected to glue application and cutting-out processing and then stacked on each other. The plural stacked recording media 50 are subjected to compression bonding. Finally, removal target portions D are removed, whereby a 3D modeled object P is obtained (see FIG. 3B).

If post-processing were started in the midst of formation of a series of slice images, the order of post-processing on recording media 50 would become erroneous. To perform post-processing in correct order from the top of stacked recording media 50, an appropriate operation is to start post-processing after completion of formation of a series of slice images. This makes it easier to correlate the slice images with the control data than in a case that post-processing is started in the midst of formation of a series of slice images.

In the image forming apparatus 12, high-speed processing of several hundred pages per minute, for example, is possible. On the other hand, the processing speed (lamination rate) of the post-processing apparatus 14 is as very low as about several millimeters per hour. Thus, the processing speed of the overall process to manufacture of a 3D modeled object is limited by the processing speed of the post-processing apparatus 14. If control data are generated according to the processing speed of the post-processing apparatus 14, the information processing apparatus 10 cannot perform other processing such as rasterization of 2D image data during the generation of control data. This means reduction of the processing ability of the image forming apparatus 12.

In contrast, in the exemplary embodiment, a series of control data is stored in the storage unit and can be read out from it in performing post-processing. As a result, the process of forming slice images on recording media 50 and the process that the post-processing apparatus 14 performs 3D modeling post-processing on the recording media 50 can be isolated from each other. Thus, the processing ability of each apparatus is made higher than in the case that a series of control data is not stored in a storage unit.

The information processing apparatus 10 generates control data irrespective of post-processing of the post-processing apparatus 14. The image forming apparatus 12 forms slice images on respective recording media 50 irrespective of post-processing of the post-processing apparatus 14. Alternatively, the image forming apparatus 12 may perform another kind of image forming job before a start of post-processing on recording media 50 that are formed with slice images. That is, the image forming apparatus 12 may be an ordinary image forming apparatus that performs image formation on the basis of 2D image data rather than an image forming apparatus dedicated to 3D modeling. Furthermore, the post-processing apparatus 14 performs post-processing irrespective of slice image formation processing of the image forming apparatus 12.

### <Image Data Output Processing Program for Sample Manufacture Processing>

### (Reduction Mode)

Next, an image data output processing program of the reduction mode for sample manufacture will be described. It is assumed that the reduction ratio of reduction of an intended 3D modeled object is 1/N (N: natural number that is larger than or equal to 2) and that data indicating the reduction ratio 1/N is stored in the memory 38 in advance. Although in the exemplary embodiment the reduction ratio is acquired by reading this data from the memory 38, the invention is not limited to this case. The reduction ratio may be acquired by receiving data indicating it that is input by a user's operating the operation unit 32.

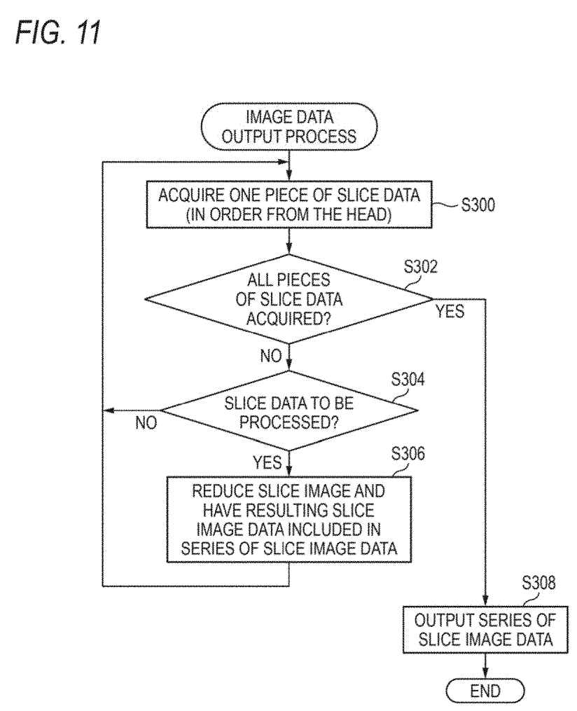

FIG. 11 is a flowchart showing an example processing procedure of an image data output processing program of the reduction mode according to the exemplary embodiment. The image data output processing program of the reduction mode is stored in the ROM 30B of the information processing apparatus 10. The image data output processing program of the reduction mode is read cut from the ROM 30B and executed by the CPU 30A of the information processing apparatus 10. Execution of the image data output processing program of the reduction mode is started upon reception of an image formation instruction or a 3D modeling instruction from a user.

Although the exemplary embodiment is directed to the case that the image data output processing program of the reduction mode is stored in the ROM 30B of the information processing apparatus 10 in advance, the invention is not limited to this case. For example, the image data output processing program of the reduction mode may be provided being stored in a computer-readable, portable storage medium such as a magneto-optical disc, a CD-ROM (compact disc-read only memory), or a USB memory or provided over a network.

First, at step S300, the CPU 30A acquires one piece of slice data of plural pieces of slice data generated by the slice processing unit 45. In the exemplary embodiment, the CPU 30A acquires the series of slice data in order starting from the head slice data.

At step S302, the CPU 30A judges whether it has acquired, at step S300, all of the plural pieces of slice data generated by the slice processing unit 45. If judging that it has acquired all of the plural pieces of slice data, the CPU 30A executes the process shown in step S308. If not, the CPU 30A executes the process shown in step S304.

At step S304, the CPU 30A judges whether the acquired slice data are slice data to be processed. In the exemplary embodiment, since the reduction ratio is 1/N, the CPU 30A employs an (n×N+1)th piece of slice data (n: integer that is larger than or equal to 0) as slice data to be processed. For example, where N is equal to “2” (reduction ratio: ½), the CPU 30A judges that a first, third, fifth, seventh, . . . slice data as slice data to be processed.

If the acquired slice data is slice data to be processed, the CPU 30A executes the process shown in step S306. If not, the CPU 30A executes the process shown in step S300.

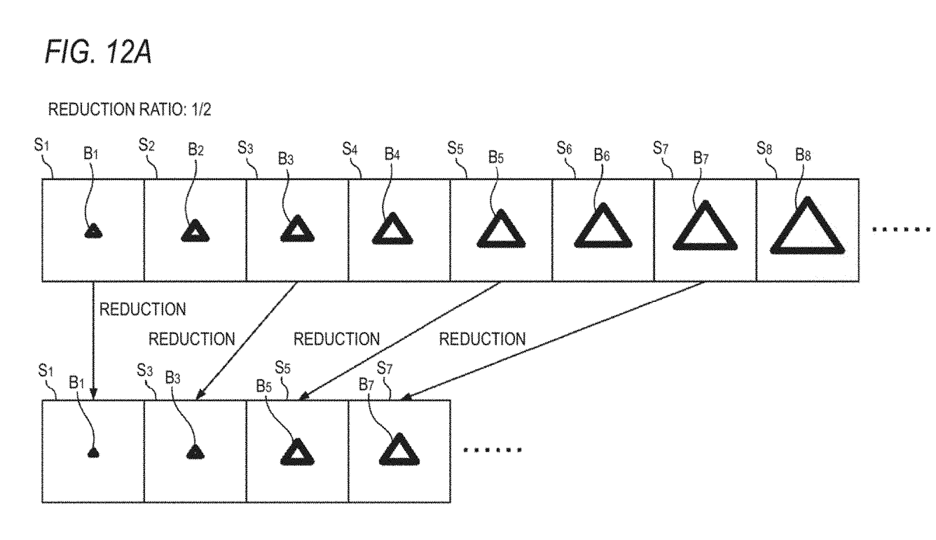

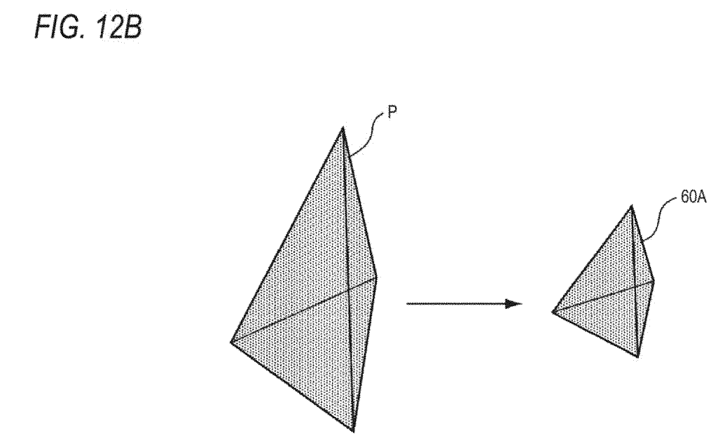

At step S306, the CPU 30A reduces the slice image corresponding to the acquired slice data and has resulting slice image data included in a series of slice image data as a target of image formation by the image forming apparatus 12. For example, as shown in FIG. 12A, slice images B₁, B₃, B₅, B₇, . . . corresponding to first, third, fifth, seventh, . . . slice data S₁, S₃, S₅, S₇ . . . are reduced at a reduction ratio ½ and slice image data of the slice data S₁, S₃, S₅, S₇, . . . are included in a series of slice image data.

At step S308, the series of slice image data is output to the control data generation unit 47 and the raster processing unit 42 (or file format conversion unit 40). Then the execution of the image data output processing program of the reduction mode is finished.

In the example of FIG. 12A, while the slice image data are thinned out (i.e., taken every other piece of slice image data), the slice images corresponding to the acquired slice data are reduced at the reduction ratio ½. As a result, as shown in FIG. 12B, a sample 60A that is reduced at the reduction ratio ½ in each of the X-axis direction, the Y-axis direction, and the Z-axis direction is manufactured as a reduced version of an intended 3D modeled object P.

In the reduction mode, a sample 3D modeled object in which the overall shape of an intended 3D modeled object is reproduced is manufactured while the number of recording media 50, the cost of image formation (e.g., the amounts of colorants used), and the times to perform image formation and post-processing are saved.

### (Partial Modeling Mode)

Next, an image data output processing program of the partial modeling mode for sample manufacture will be described. It is assumed that data indicating a region(s) corresponding to one (or plural) portion of an intended 3D modeled object are stored as a target region in the memory 38 in advance, and that the data indicating the target region are data indicating ranges in the X-axis direction, the Y-axis direction, and the Z-axis direction, for example. Although in the exemplary embodiment the target region is acquired by reading the data stored in the memory 38, the invention is not limited to this case. The target region may be acquired by receiving data indicating it that are input by a user's operating the operation unit 32. The target region may be represented as a function P (x, y, z), wherein x is a coordinate value(s) of the X-axis, y is a coordinate value(s) of the Y-axis, and z is a coordinate value(s) of the Z-axis.

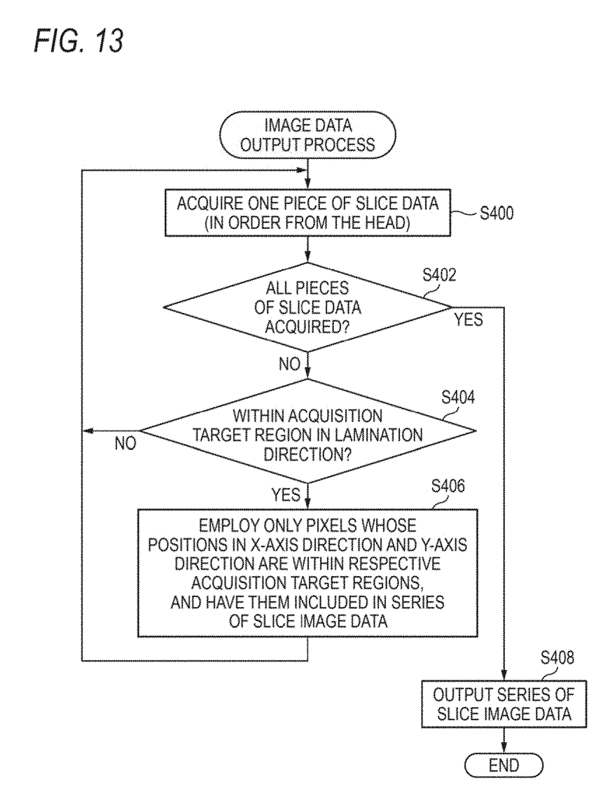

FIG. 13 is a flowchart showing an example processing procedure of an image data output processing program of the partial modeling mode according to the exemplary embodiment. The image data output processing program of the partial modeling mode is stored in the ROM 30B of the information processing apparatus 10. The image data output processing program of the partial modeling mode is read out from the ROM 30B and executed by the CPU 30A of the information processing apparatus 10. Execution of the image data output processing program of the partial modeling mode is started upon reception of an image formation instruction or a 3D modeling instruction from a user.

Although the exemplary embodiment is directed to the case that the image data output processing program of the partial modeling mode is stored in the ROM 30B of the information processing apparatus 10 in advance, the invention is not limited to this case. For example, the image data output processing program of the partial modeling mode maybe provided being stored in a computer-readable, portable storage medium such as a magneto-optical disc, a CD-ROM (compact disc-read only memory), or a USB memory or provided over a network.

First, at step S400, the CPU 30A acquires one of plural pieces of slice data generated by the slice processing unit 45. In the exemplary embodiment, the CPU 30A acquires the series of slice data in order starting from the head slice data.

At step S402, the CPU 30A judges whether it has acquired, at step S400, all of the plural pieces of slice data generated by the slice processing unit 45. If judging that it has acquired all of the plural pieces of slice data, the CPU 30A executes the process shown in step S408. If not, the CPU 30A executes the process shown in step S404.

At step S404, the CPU 30A judges whether the acquired slice data are slice data in a target region in the lamination direction. In the exemplary embodiment, it is judged that the acquired slice data are slice data in a target region in the lamination direction if the position in the Z-axis direction is included in the range of the target region in the Z-axis direction.

If the acquired slice data is slice data in the target region in the lamination direction, the CPU 30A executes the process shown in step S406. If not, the CPU 30A executes the process shown in step S400.

At step S406, the CPU 30A employs, as target pixels of image formation by the image forming apparatus 12, only pixels, whose positions in the X-axis direction and the Y-axis direction are within respective target regions, of a slice image corresponding to the acquired slice data (i.e., has these pixels included in a series of slice image data). That is, pixels, at least one of whose positions in the X-axis direction and the Y-axis direction is out of the target region, of the slice image corresponding to the acquired slice data are deleted.

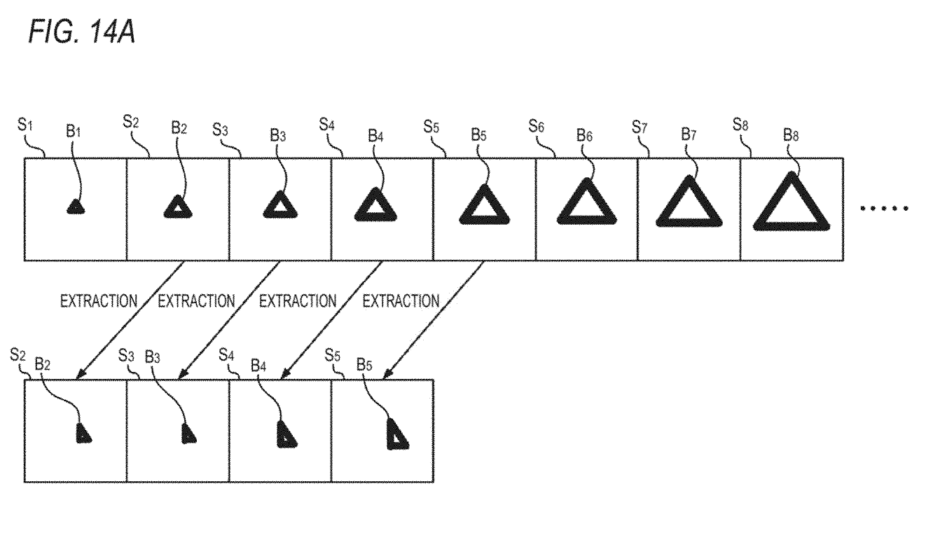

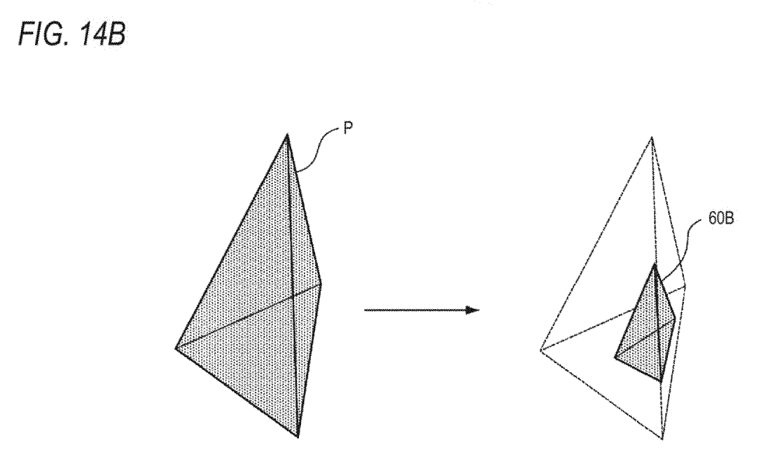

For example, as shown in FIG. 14A, if only second, third, fourth, and fifth slice data S₂, S₃, S₄, and S₅ . . . are included in a target region in the Z-axis direction, portions, outside at least one of target regions in the X-axis direction and the Y-axis direction, of slice images B₂, B₃, B₄, and B₅ corresponding to these slice data S₂, S₃, S₄, and S₅ are erased and their remaining portions are included in a series of slice image data.

At step S408, the series of slice image data is output to the control data generation unit 47 and the raster processing unit 42 (or file format conversion unit 40). Then the execution of the image data output processing program of the partial modeling mode is finished.

In the example of FIG. 14A, the portions, outside at least one of the target regions in the X-axis direction and the Y-axis direction, of the slice images corresponding to the slice data included in the target region in the Z-axis direction are erased. As a result, as shown in FIG. 14B, a sample 60B in which only a portion within the target region is extracted is manufactured from an intended 3D modeled object P.

In the partial modeling mode, a sample 3D modeled object in which a target region of an intended 3D modeled object is reproduced in terms of modeling accuracy and hue accuracy is manufactured while the number of recording media 50, the cost of image formation (e.g., the amounts of colorants used), and the times to perform image formation and post-processing are saved.

### (Partial Coloring Mode)

Next, an image data output processing program of the partial coloring mode for sample manufacture will be described. It is assumed that data indicating a region(s) corresponding to one (or plural portion of an intended 3D modeled object are stored as a target region in the memory 38 in advance, and that the data indicating the target region are data indicating ranges in the X-axis direction, the Y-axis direction, and the Z-axis direction, for example. Although in the exemplary embodiment the target region is acquired by reading the data stored in the memory 38, the invention is not limited to this case. The target region may be acquired by receiving data indicating it that are input by a user's operating the operation unit 32. The target region may be represented as a function F (x, y, z), wherein x is a coordinate value(s) of the X-axis, y is a coordinate value(s) of the Y-axis, and z is a coordinate value (s) of the Z-axis.

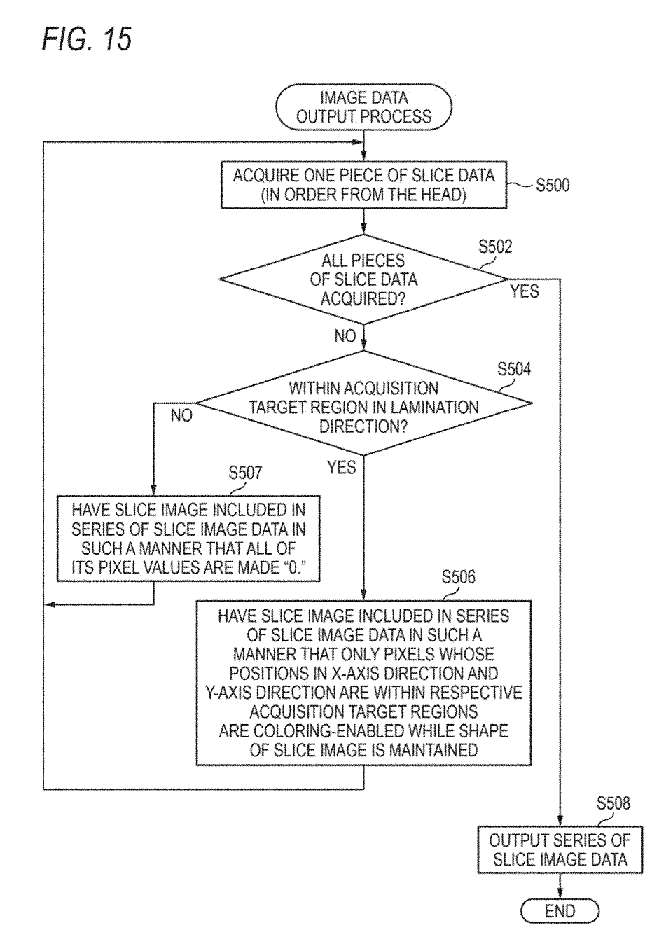

FIG. 15 is a flowchart showing an example processing procedure of an image data output processing program of the partial coloring mode according to the exemplary embodiment. The image data output processing program of the partial coloring mode is stored in the ROM 30B of the information processing apparatus 10. The image data output processing program of the partial coloring mode is read out from the ROM 30B and executed by the CPU 30A of the information processing apparatus 10. Execution of the image data output processing program of the partial coloring mode is started upon reception of an image formation instruction or a 3D modeling instruction from a user.

Although the exemplary embodiment is directed to the case that the image data output processing program of the partial coloring mode is stored in the ROM 30B of the information processing apparatus 10 in advance, the invention is not limited to this case. For example, the image data output processing program of the partial coloring mode may be provided being stored in a computer-readable, portable storage medium such as a magneto-optical disc, a CD-ROM (compact disc-read only memory), or a USB memory or provided over a network.

First, at step S500, the CPU 30A acquires one of plural pieces of slice data generated by the slice processing unit 45. In the exemplary embodiment, the CPU 30A acquires the series of slice data in order starting from the head slice data.

At step S502, the CPU 30A judges whether it has acquired, at step S500, all of the plural pieces of slice data generated by the slice processing unit 45. If judging that it has acquired all of the plural pieces of slice data, the CPU 30A executes the process shown in step S508. If not, the CPU 30A executes the process shown in step S504.

At step S504, the CPU 30A judges whether the acquired slice data are slice data in a target region in the lamination direction. In the exemplary embodiment, it is judged that the acquired slice data are slice data in a target region in the lamination direction if the position in the Z-axis direction is included in the range of the target region in the Z-axis direction.

If the acquired slice data is slice data in the target region in the lamination direction, the CPU 30A executes the process shown in step S506. If not, the CPU 30A executes the process shown in step S507.

At step S506, the CPU 30A makes a slice image corresponding to the acquired slice data a target of image formation by the image forming apparatus 12, that is, has the slice image included in a series of slice image data in such a manner as to enable reproduction of the colors of only pixels, whose positions in the X-axis direction and the Y-axis direction are within respective target regions, of the slice image. That is, the pixel values of pixels, at least one of whose positions in the X-axis direction and the Y-axis direction is out of the target region, of the slice image corresponding to the acquired slice data are made “0.” Then the CPU 30A executes the process shown in step S500.

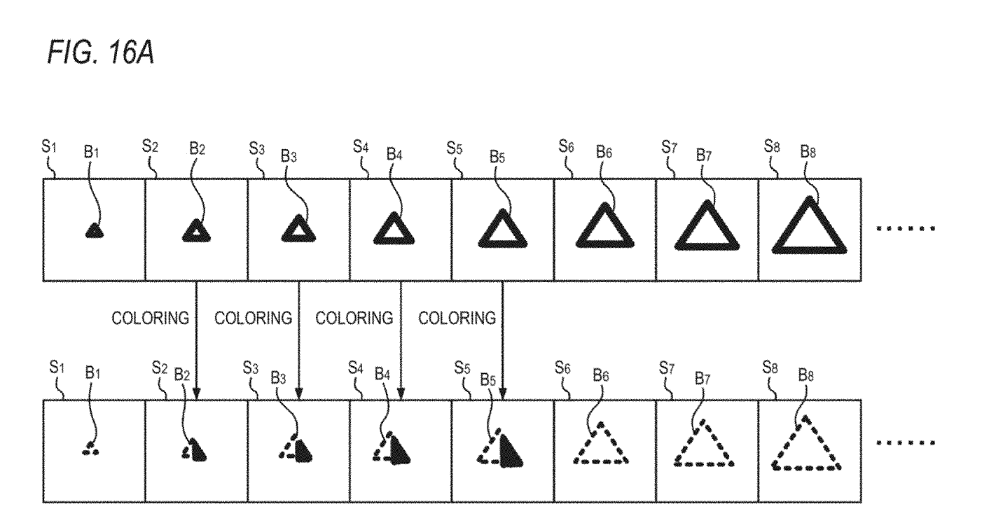

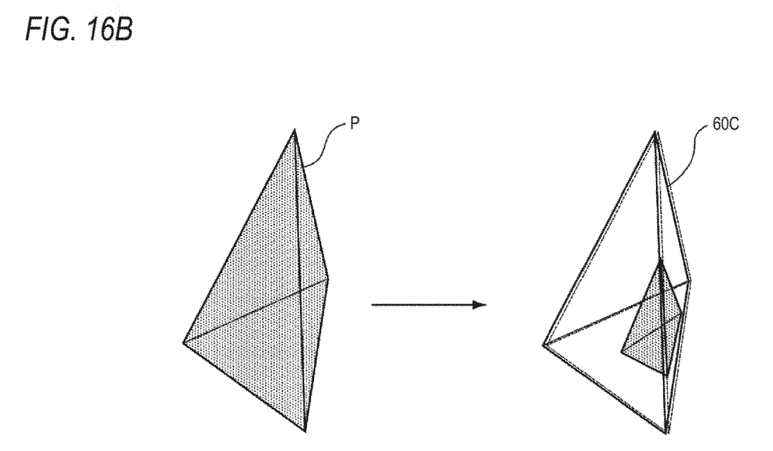

For example, as shown in FIG. 16A, if only second, third, fourth, and fifth slice data S₂, S₃, S₄, and S₅ are included in a target region in the Z-axis direction, the slice data S₂, S₃, S₄, and S₅ are included in a series of slice image data in such a manner that the pixel values of portions, outside at least one of target regions in the X-axis direction and the Y-axis direction, of slice images B₂, B₃, B₄, and B₅ corresponding to these slice data S₂, S₃, S₄, and S₅ are made “0”.

At step S507, the CPU 30A causes the pixel values of all pixels of the slice image corresponding to the acquired slice data to be made “0” and makes this slice image a target of image formation by the image forming apparatus 12, that is, has this slice image included in a series of slice image data. Then the CPU 30A executes the process shown in step S500.

For example, as shown in FIG. 16A, slice images B₁, B₆, B₇, and B₈ . . . corresponding to these slice data S₁, S₆, S₇, and S₈ . . . that are not included in the target region in the Z-axis direction are included in a series of slice image data in such a manner that the pixel values of ail of their pixels are made “0.”

At step S508, the series of slice image data is output to the control data generation unit 47 and the raster processing unit 42 (or file format conversion unit 40). Then the execution of the image data output processing program of the partial coloring mode is finished.

In the example of FIG. 16A, the pixel values of each slice image corresponding to slice data not included in the target region in the Z-axis direction are made “0” and the pixel values of pixels, not included in at least one of target regions in the X-axis direction and the Y-axis direction, of each slice image corresponding to slice data included in the target region in the Z-axis direction are also made “0.” As a result, as shown in FIG. 16B, a sample 60C in which only a portion within the target region is colored is manufactured from an intended 3D modeled object.

In the partial coloring mode, a sample 3D modeled object in which the hue accuracy of a target region of an intended 3D modeled object in terms of and the size of the intended 3D modeled object are reproduced is manufactured while the cost of image formation (e.g., the amounts of colorants used) and the time to perform image formation are saved.

### (Thick Paper Mode)

Next, an image data output processing program of the thick paper mode for sample manufacture will be described. It is assumed that data indicating a type and a thickness of thick paper sheets to be used for manufacture of a sample and data indicating a target region that are data indicating ranges in the X-axis direction, the Y-axis direction, and the Z-axis direction are stored in the memory 38.

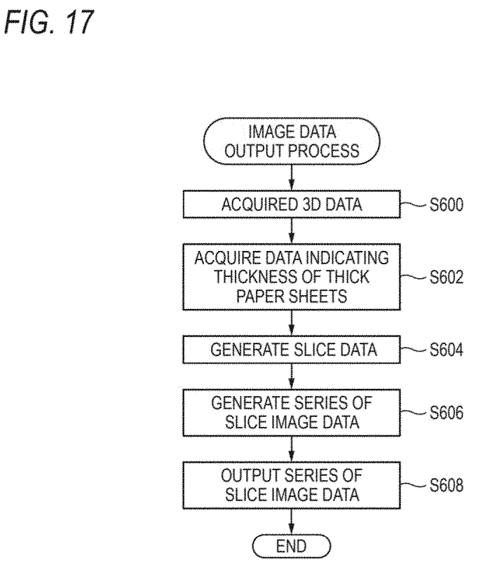

FIG. 17 is a flowchart showing an example processing procedure of an image data output processing program of the thick paper mode according to the exemplary embodiment. The image data output processing program of the thick paper mode is stored in the ROM 30B of the information processing apparatus 10. The image data output processing program of the thick paper mode is read out from the ROM 30B and executed by the CPU 30A of the information processing apparatus 10. Execution of the image data output processing program of the thick paper mode is started upon reception of an image formation instruction or a 3D modeling instruction from a user.

Although the exemplary embodiment is directed to the case that the image data output processing program of the thick paper mode is stored in the ROM 30B of the information processing apparatus 10 in advance, the invention is not limited to this case. For example, the image data output processing program of the thick paper mode may be provided being stored in a computer-readable, portable storage medium such as a magneto-optical disc, a CD-ROM (compact disc-read only memory), or a USB memory or provided over a network.

First, at step S600, the CPU 30A acquires 3D data. At step S602, the CPU 30A recognizes a thickness of thick paper sheets to be used for manufacturing a sample by acquiring data indicating it.

At step S604, the CPU 30A generates plural pieces of slice data by slicing a 3D model M represented by the acquired 3D data by slicing planes that are spaced from each other by the recognized thickness. At step S606, the CPU 30A generates a series of slice image data on the basis of the generated plural pieces of slice data.

At step S608, the CPU 30A outputs the series of slice image data to the control data generation unit 47 and the raster processing unit 42 (or file format conversion unit 40). Then the execution of the image data output processing program of the thick paper mode is finished.

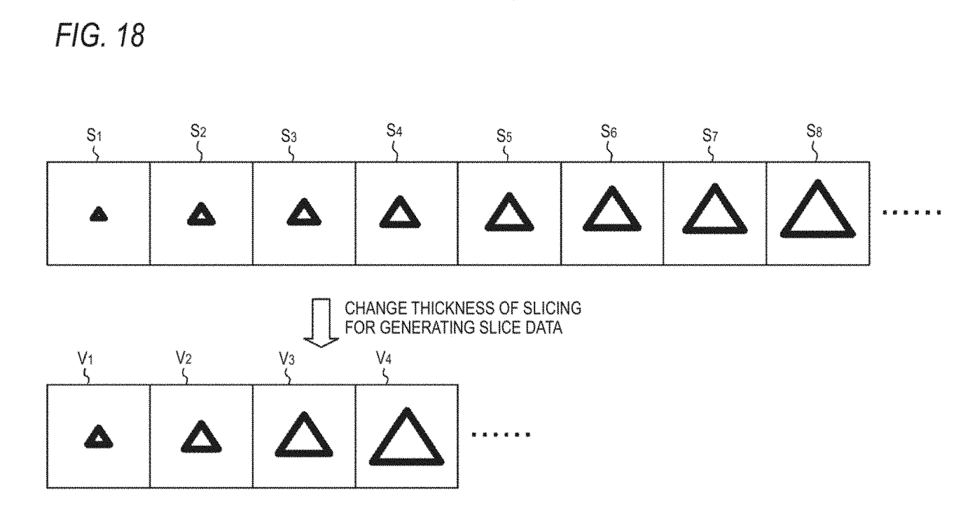

For example, as shown in FIG. 18, in the thick paper mode, slice data V₁, V₂, V₃, . . . are generated that are different from first, second, third . . . slice data S₁, S₂, S₃, . . . that are slice data for manufacture of a 3D modeled object. By manufacturing a sample using thick recording media 50 that are thicker than recording media 50 to be used for manufacturing the 3D modeled object, the number of recording media 50 used is reduced.

In the thick paper mode, a sample 3D modeled object in which the size of an intended 3D modeled object is reproduced is manufactured while the number of recording media 50 used, the cost of image formation (e.g., the amounts of colorants used), and the times to perform image formation and post-processing are saved.

Although the example in which slice data are generated in a case that thick recording media 50 (thick paper sheets) are used has been described above including how to generate the slice data, the invention is not limited to this example. Slice data V₁, V₂, V₃, . . . to be used for manufacturing a sample in the thick paper mode may be obtained by extracting, every [d/p] pieces, slice data that are obtained by shifting a 3D model M at a lamination pitch p, where [d/p] means an integer part of a quotient d/p and d is the thickness of thick paper sheets.

### (Non-Coloring Mode)

Next, an image data output processing program of the non-coloring mode for sample manufacture will be described.

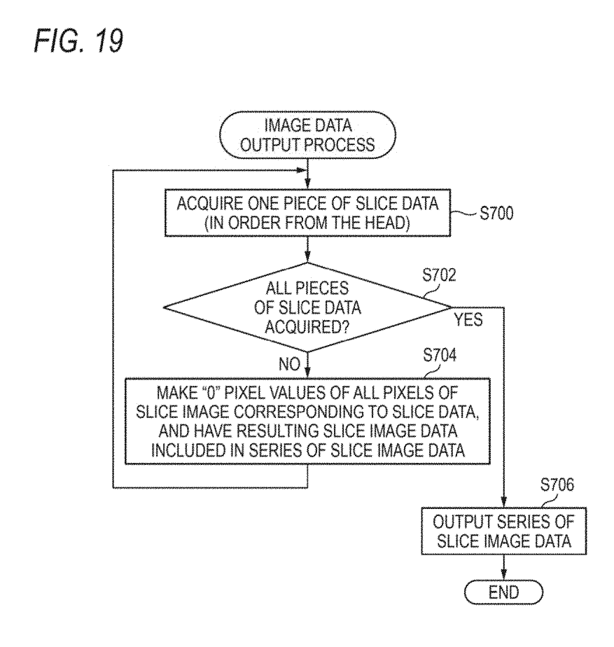

FIG. 19 is a flowchart showing an example processing procedure of an image data output processing program of the non-coloring mode according to the exemplary embodiment. The image data output processing program of the non-coloring mode is stored in the ROM 30B of the information processing apparatus 10. The image data output processing program of the non-coloring mode is read out from the ROM 30B and executed by the CPU 30A of the information processing apparatus 10. Execution of the image data output processing program of the non-coloring mode is started upon reception of an image formation instruction or a 3D modeling instruction from a user.

Although the exemplary embodiment Is directed to the case that the image data output processing program of the non-coloring mode is stored in the ROM 30B of the information processing apparatus 10 in advance, the invention is not limited to this case. For example, the image data output processing program of the non-coloring mode may be provided being stored in a computer-readable, portable storage medium such as a magneto-optical disc, a CD-ROM (compact disc-read only memory), or a USB memory or provided over a network.

First, at step S700, the CPU 30A acquires one of plural pieces of slice data generated by the slice processing unit 45. In the exemplary embodiment, the CPU 30A acquires the series of slice data in order starting from the head slice data.

At step S702, the CPU 30A judges whether it has acquired, at step S300, all of the plural pieces of slice data generated by the slice processing unit 45. If judging that it has acquired all of the plural pieces of slice data, the CPU 30A executes the process shown in step S706. If not, the CPU 30A executes the process shown in step S704.

At step S704, the CPU 30A makes “0” the pixel values of all pixels of a slice image corresponding to the acquired slice data and has resulting slice image data included in a series of slice image data as a target of image formation by the image forming apparatus 12. Then the CPU 30A executes the process shown in step S700.

At step S706, the series of slice image data is output to the control data generation unit 47 and the raster processing unit 42 (or file format conversion unit 40). Then the execution of the image data output processing program of the non-coloring mode is finished.

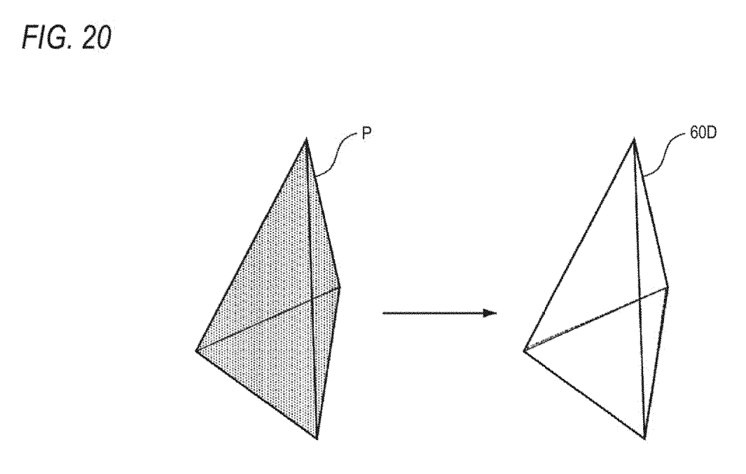

As a result, as shown in FIG. 20, a colorless sample 60B having the same shape and size as an intended 3D modeled object P is manufactured.

In the non-coloring mode, a sample 3D modeled object in which an intended 3D modeled object is reproduced in terms of size and accuracy of 3D modeling is manufactured while the cost of image formation (e.g., the amounts of colorants used) is saved.

In the non-coloring mode, 3D modeling is performed without performing image formation on recording media 50. Where the image forming apparatus 12 and the post-processing apparatus 14 are in an in-line arrangement (see FIG. 2), it is appropriate to cause recording media 50 to pass through an ordinary IOT path without performing image formation. On the other hand, where the image forming apparatus 12 and the post-processing apparatus 14 are in a near-line or offline arrangement, it is appropriate that the image forming apparatus 12 not be used, the information processing apparatus 10 generate only control data, and the post-processing apparatus 14 be supplied with recording media 50 in a number corresponding to the number of pieces of slice data and perform post-processing according to the control data.

Although in the exemplary embodiment image data output processing is performed using plural pieces of slice data in the reduction mode, the partial modeling mode, the partial coloring mode, or the non-coloring mode, the invention is not limited to this case. For example, in the reduction mode, it is possible to modify 3D data so that it comes to represent a reduced version of an intended 3D modeled object and perform the above-described 3D data processing on the basis of the modified 3D data. In the partial modeling mode, it is possible to modify 3D data so that only one or plural portions of an intended 3D modeled object are extracted and perform the above-described 3D data processing on the basis of the modified 3D data.

In the partial coloring mode, it is possible to modify 3D data so that only one or plural portions of an intended 3D modeled object will be colored and perform the above-described 3D data processing on the basis of the modified 3D data. In the non-coloring mode, it is possible to modify 3D data so that a sample of an intended 3D modeled object will not be colored and perform the above-described 3D data processing on the basis of the modified 3D data.

The above-described information processing apparatus, image forming apparatus, and programs according to the exemplary embodiment are just examples, and it goes without saying that they can be modified without departing from the spirit and scope of the invention.

What is claimed is:

1. An information processing apparatus comprising:
a generation unit chat generates plural pieces of slice data by slicing, by plural planes, a sample in which a 3D modeled object as represented by 3D data is reproduced at least partially in terms of at least one of color and shape; and
an output unit that generates control data that correspond to the plural pieces of slice data and allow a post-processing apparatus to perform post-processing for manufacture of the 3D modeled object, and outputs the generated control data.

2. The information processing apparatus according to claim 1, wherein:
the generation unit generates reduced slice image data by reducing, at a predetermined reduction ratio, slice images corresponding to part of plural respective pieces of slice data generated by slicing the 3D modeled object by plural planes; and
the output unit generates image formation information that allows an image forming apparatus to form slice images corresponding to the respective reduced slice image data on recording media, and outputs the generated image formation information to the image forming apparatus.

3. The information processing apparatus according to claim 2, wherein the generation unit generates the reduced slice image data by extracting the part of the plural pieces of slice data and reducing slice images corresponding to the extracted pieces of slice data, respectively, at the predetermined reduction ratio.

4. The information processing apparatus according to claim 1, wherein:
the generation unit extracts slice image data in a target region corresponding to a portion of the 3D modeled object from slice images corresponding to the plural respective pieces of slice data; and
the output unit generates image formation information that allows an image forming apparatus to form, on recording media, slice images corresponding to the slice image data in the target region extracted by the generation unit, and outputs the generated image formation information to the image forming apparatus.

5. The information processing apparatus according to claim 4, further comprising a reception unit that receives data indicating the target region,
wherein the generation unit extracts the slice image data in the target region indicated by the data received by the reception unit from the slice images corresponding to the plural respective pieces of slice data.

6. The information processing apparatus according to claim 1, wherein:
the generation unit generates slice image data that allow only a target region corresponding a portion of the 3D modeled object to be colored on the basis of slice images corresponding to the plural respective pieces of slice data; and
the output unit generates image formation information that allows an image forming apparatus to form, on recording media, slice images corresponding to the slice image data generated by the generation unit, and outputs the generated image formation information the image forming apparatus.

7. The information processing apparatus according to claim 6, further comprising a reception unit that receives data indicating the target region,
wherein the generation unit generates slice image data that allow only the target region indicated by the data received by the reception unit to be colored on the basis of the slice images corresponding to the plural respective pieces of slice data.

8. The information processing apparatus according to claim 1, wherein:
the generation unit generates plural pieces of slice data by slicing the 3D modeled object by plural planes according to a thickness of recording media; and
the output unit generates image formation information that allows an image forming apparatus to form slice images corresponding to the plural respective slice data generated by the generation unit on recording media, and outputs the generated image formation information to the image forming apparatus.

9. The information processing apparatus according to claim 1, wherein the output unit outputs, to the post-processing apparatus, control data that allow the post-processing apparatus to perform post-processing for manufacture of the sample without outputting, to the image forming apparatus, image formation information that allows the image forming apparatus to form, on recording media, slice images corresponding to the slice image data generated by the generation unit.

10. The information processing apparatus according to claim 2, wherein the output unit outputs, to the post-processing apparatus, control data that allow the post-processing apparatus to perform post-processing for manufacture of the sample without outputting, to the image forming apparatus, image formation information that allows the image forming apparatus to form, on recording media, slice images corresponding to the slice image data generated by the generation unit.

11. The information processing apparatus according to claim 3, wherein the output unit outputs, to the post-processing apparatus, control data that allow the post-processing apparatus to perform post-processing for manufacture of the sample without outputting, to the image forming apparatus, image formation information that allows the image forming apparatus to form, on recording media, slice images corresponding to the slice image data generated by the generation unit.

12. The information processing apparatus according to claim 4, wherein the output unit outputs, to the post-processing apparatus, control data that allow the post-processing apparatus to perform post-processing for manufacture of the sample without outputting, to the image forming apparatus, image formation information that allows the image forming apparatus to form, on recording media, slice images corresponding to the slice image data generated by the generation unit.

13. The information processing apparatus according to claim 5, wherein the output unit outputs, to the post-processing apparatus, control data that allow the post-processing apparatus to perform post-processing for manufacture of the sample without outputting, to the image forming apparatus, image formation information that allows the image forming apparatus to form, on recording media, slice images corresponding to the slice image data generated by the generation un it.

14. The information processing apparatus according to claim 6, wherein the output unit outputs, to the post-processing apparatus, control data that allow the post-processing apparatus to perform post-processing for manufacture of the sample without outputting, to the image forming apparatus, image formation information that allows the image forming apparatus to form, on recording media, slice images corresponding to the slice image data generated by the generation unit.

15. The information processing apparatus according to claim 7, wherein the output unit outputs, to the post-processing apparatus, control data that allow the post-processing apparatus to perform post-processing for manufacture of the sample without outputting, to the image forming apparatus, image formation information that allows the image forming apparatus to form, on recording media, slice images corresponding to the slice image data generated by the generation unit.

16. The information processing apparatus according to claim 8, wherein the output unit outputs, to the post-processing apparatus, control data that allow the post-processing apparatus to perform post-processing for manufacture of the sample without outputting, to the image forming apparatus, image formation information that allows the image forming apparatus to form, on recording media, slice images corresponding to the slice image data generated by the generation unit.

17. A 3D modeling system comprising:
the information processing apparatus according to claim 1;
an image forming apparatus that forms images on respective recording media on the basis of imago formation information generated by the information processing apparatus; and
a post-processing apparatus that performs post-processing for manufacture of a 3D modeled object on recording media on which respective slice images have been formed by the image forming apparatus, according to control data that have been generated by the information processing apparatus so as to correspond to the slice images.

18. A computer readable medium storing a program for causing a computer to function as:
a generation unit that generates plural pieces of slice data by slicing, by plural planes, a sample in which a 3D modeled object as represented by 3D data is reproduced at least partially in terms of at least one of color and shape; and
an output unit that generates control data that correspond to the plural pieces of slice data and allow a post-processing apparatus to perform post-processing for manufacture of the 3D modeled object, and outputs the generated control data.
